(19) United States
(12) Patent Application Publication
(10) Pub. No.: US 2020/0216005 A1
(43) Pub. Date: Jul. 9, 2020

(54) METHOD FOR OPERATING A SAFETY BELT SYSTEM

(71) Applicant: ZF AUTOMOTIVE GERMANY GMBH, Alfdorf (DE)

(72) Inventor: Michael Stegmeier, Schwäbisch Gmünd (DE)

(21) Appl. No.: 16/649,264

(22) PCT Filed: Sep. 24, 2018
(86) PCT No.: PCT/EP2018/075769

§ 371 Date: Mar. 20, 2020

(30) Foreign Application Priority Data
Sep. 29, 2017 (DE) 102017122688.5

(51) Int. Cl. B60R 21/015; B60R 22/48

(52) U.S. Cl. CPC B60R 21/01548; B60R 21/01554; B60R 21/01504; B60R 2022/4825; B60R 22/48

(57) ABSTRACT

A method for operating a seat belt system (10) for an occupant (12) in a vehicle (14) comprises a belt webbing for restraining the occupant (12), a belt buckle (26) and a sensor (28) for sensing the webbing extension. The method initiates a reaction when the webbing extension exceeds a threshold which takes the minimum webbing extension after the closing of the belt buckle (26) into account.

### RELATED APPLICATIONS

This application filed under 35 U.S.C § 371 is a national phase application of International Application Serial Number PCT/EP2018/075769 filed Sep. 24, 2018, which claims the benefit of German Application No. 10 2017 122 688.5 filed Sep. 29, 2017, the subject matter of which are incorporated herein by reference in their entirety.

### TECHNICAL FIELD

The invention relates to a method for operating a seat belt system for an occupant in a vehicle.

Seat belt systems for vehicles are known. The effect seat belt systems have on the belted occupant and thus the protection provided by a seat belt are substantially dependent on the (sitting) position of the belted occupant. Studies from accident is research have found that, for reasons of comfort, a significant share of the occupants adopts a sitting position in the vehicle that deviates from an optimum sitting position. That is to say that the occupant is positioned relative to the safety devices, such as e.g. belt webbing and airbags, in a way that, in the case of restraint, the seat belt system cannot provide its full protective effect. This may entail an increased load of the occupant in the case of restraint and may increase the risk of injury.

### SUMMARY

It is the object of the invention to provide a method for operating a seat belt system that guarantees an improved protective effect.

For achieving the object, a method for operating a seat belt system for an occupant in a vehicle is provided. The seat belt system comprises a webbing for restraining the occupant, a belt buckle for closing the seat belt system and a sensor for sensing the webbing extension. Within the scope of the method, a reaction is initiated when the webbing extension exceeds a threshold. Accordingly, in the threshold the minimum webbing extension after the closing of the belt buckle is taken into account. In accordance with the invention, the webbing extension is the distance which the webbing has been extended or unwound from the belt reel as compared to a reference value. The reference value may be, for example, the position of the webbing adopted by the latter in the attitude-stable position in which the webbing is provided in the vehicle for being extended by the occupant. As the threshold takes the minimum webbing extension after the closing of the belt buckle into account, the seat belt system is adapted and, resp., calibrated to the occupant, i.e. the body shape of the occupant and, resp., the circumference of the latter is considered in the threshold. In this way, a threshold individually adapted to the occupant and therefore an improved protective effect can be provided.

When the occupant belted by the webbing is seated in an optimum sitting position, for example sitting upright with his/her back leaned against the backrest of is the occupant's seat, usually the webbing extension is minimal. Any change of the position of the occupant vis-a-vis the optimum sitting position, for example because the occupant leans forward or because the occupant extends the webbing farther so that the webbing is not in tight contact with his/her body, thus results in higher webbing extension. In the suggested method, an excessive incorrect attitude of the occupant or incorrect positioning of the webbing results in the fact that the webbing extension exceeds the threshold and a reaction is triggered. Said incorrect attitude or incorrect positioning can be corrected by means of the reaction. In this way, the occupant's position relative to the seat belt system is improved and thus the protective effect of the seat belt system is increased in the case of restraint.

In accordance with one embodiment, the threshold takes account of the minimum webbing extension within 30 seconds, preferably within 20 seconds, especially within 10 seconds after the closing of the belt buckle. The underlying idea consists in the fact that occupants adopt the optimum sitting position at least for a short time shortly after fastening the seat belt, i.e. closing the belt buckle, before later they deviate from said sitting position e.g. for reasons of comfort or fatigue. By taking the minimum webbing extension within the time window shortly after fastening the seat belt into account, the threshold is ensured to be at least as close to the optimum threshold as possible which corresponds to the threshold taking the optimum sitting position into account.

As the occupant cannot be ensured to adopt an optimum sitting position within a set time window, the threshold can take the minimum webbing extension after the closing of the belt buckle into account continuously or at regular intervals, for example at a frequency of 100 Hz. Since an improved sitting position usually involves reduced webbing extension after fastening the seat belt, in this way the threshold can be updated and thus improved over the entire period of time in which the occupant is belted. This helps to improve the accuracy of when a reaction is triggered.

Further, the threshold can take the sitting position, especially the torso position, of the occupant into account by means of a sensor. For this purpose, e.g. a camera or is a (pressure) sensor may be provided in the backrest. In this way, the threshold and, consequently, the protective effect of the seat belt system can be improved, for example by the threshold being appropriately reduced when the occupant is bent forward, so that said (incorrect) attitude can be corrected already by a reaction before the occupant has leaned back for the first time.

The threshold may be provided to take into account the seat position of the occupant's seat, the seat position of the seat disposed in the vehicle in front of the occupant's seat and/or the position of a steering wheel disposed in the vehicle in front of the occupant's seat. In accordance with the invention, the term “in the vehicle in front of” means being arranged more closely to the front end of the vehicle, especially with the front end facing to the primary driving direction of the vehicle. If the vehicle has no defined front end or the viewing direction of the occupant does not correspond to the driving direction, the term “in the vehicle in front of” may also mean “in the viewing direction in front of the occupant”. Thus, the position of the occupant relative to his/her environment can be taken into account in the threshold, thus ensuring, for example, the occupant not to collide with the steering wheel or the front seat in the case of restraint.

In one embodiment, the threshold may take the position of an airbag or, resp., the positions of several airbags into account. This helps to ensure that a reaction is triggered each time when the occupant's position relative to an airbag results in a reduced protective effect.

In another embodiment, the threshold may take the position of an airbag into account which is disposed opposite to the occupant in the driving direction. This helps to guarantee that a reaction is triggered each time when the occupant is too close to the airbag which, in the case of restraint, is provided primarily for the occupant's impact. Thus, the airbag can be prevented, for example, from contacting the occupant already before it is completely deployed, instead of the occupant immersing into the already expanded airbag.

The reaction being triggered when the threshold is exceeded may comprise transmitting an acoustic and/or optical signal by way of an output device so as to transfer information to the occupant. For example, loudspeakers or a display which are especially present already in the vehicle and may have further functions may be provided as output device. In this way, it can be notified to the occupant that his/her sitting position deviates too far from the optimum sitting position so that the occupant can correct his/her sitting position.

Furthermore, the reaction may comprise activating a belt tensioner for tensioning the webbing so that the restraining force of the webbing is increased. The restraining force in this case is the tensile force by which the webbing is pulled in the direction of the belt reel. This means that the pressure exerted by the webbing on the occupant is increased so that the occupant can be prompted, for example, by low tensile force to adapt his/her sitting position. As an alternative, a change of position of the occupant can be enforced by higher tensile force, e.g. to right up a sleeping person and to move him/her to a safe position.

The restraining force of the webbing may be increased by a fixed value, a value increasing continuously in time or a value varying in time. When the restraining force of the webbing is increased by a value varying in time, energy pulses which the occupant perceives as pressure variations are introduced into the webbing. Via the strength and the course of the variation of the restraining force, the occupant can be prompted in different ways to adapt his/her sitting position. For example, the prompt may be more imperative when a crash is directly imminent than when the vehicle is stopped.

### BRIEF DESCRIPTION OF THE DRAWINGS

Further advantages and features will be evident from the following description in combination with the attached drawings, wherein:

FIGS. 1 and 2 show in a schematic view in which way a seat belt system for an occupant in a driver seat of an automotive vehicle is operated by means of the method according to the invention, and

FIGS. 3 and 4 show in a schematic view in which way a seat belt system for an occupant on a backseat of an automotive vehicle is operated by means of the method according to the invention,

### DESCRIPTION

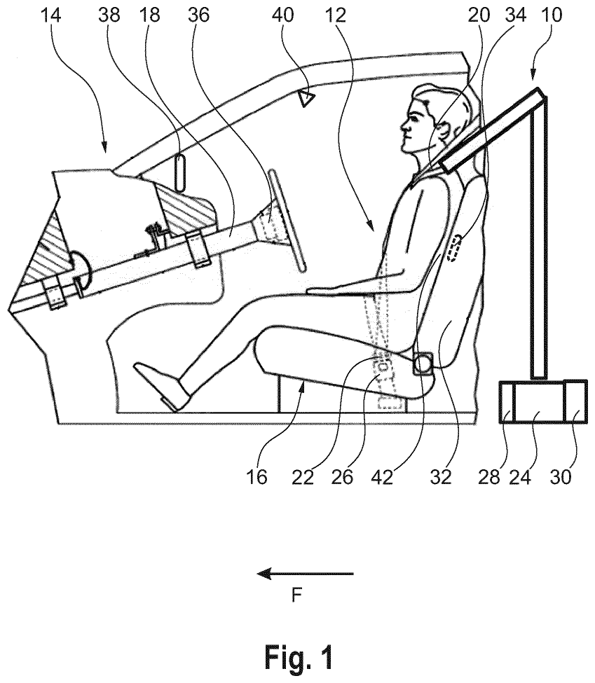

In FIG. 1, a seat belt system 10 for an occupant 12 in an automotive vehicle 14 is shown. The occupant 12 sits in a driver seat 16 of the automotive vehicle 14. A steering wheel 18 of the automotive vehicle 14 is disposed in front of the driver seat 16.

The seat belt system 10 comprises a belt webbing 20 including a belt tongue 22, a belt reel 24 on which the belt webbing 20 is partly wound and which exerts tensile force on the belt webbing 20 as well as a belt buckle 26 in which the belt tongue 22 can engage. The webbing 20 serves for restraining the occupant 12 in the driver seat 16 when the belt buckle 26 is closed. The belt buckle 16 is closed by the belt tongue 22 being inserted into the belt buckle 26 and engaging with the latter.

A reel rotation sensor 28 by means of which the axial rotation of the belt reel 24 and thus the webbing extension of the webbing 20 is sensed in a known way is provided on the belt reel 24.

The seat belt system 10 further comprises a belt tensioner 30 provided for tensioning the webbing 20 and, resp., winding the webbing 20 onto the belt reel 24.

The driver seat 16 includes a backrest 32 having a pressure sensor 34 configured to sense whether the occupant is leaned against the backrest 32.

Furthermore, the driver seat 16 and the backrest 32 are adjustable and can be positioned within the automotive vehicle 14 in the common way. While adjusting the driver seat 16, the method can be stopped from being carried out for the duration of the adjustment.

In order to protect the occupant 12 in the event of crash, in the steering wheel 18 an airbag 36 that can be released in a known way in the event of crash is provided.

The automotive vehicle 14 comprises a display 38 by means of which information can be visually provided to the occupant 12. In addition, or as an alternative, a loudspeaker by means of which information can be made available acoustically to the occupant 12 may be provided in the automotive vehicle 14.

Moreover, in the automotive vehicle 14 a camera 40 configured to detect the attitude and, resp., the sitting position of the occupant 12 is provided.

The driver seat 16, the belt buckle 26, the reel rotation sensor 28, the belt tensioner 30, the pressure sensor 34, the airbag 36, the display 38 and the camera 40 are connected to the vehicle computer (not shown) of the vehicle 14 in a signal-transmitting manner.

The vehicle computer is configured for controlling the afore-mentioned systems as well as for carrying out the following method to operate the seat belt system 10. In an alternative embodiment, there can be provided a separate control for carrying out the method to operate the seat belt system 10 which is connected at least to the belt s buckle 26 and the reel rotation sensor 28 in a signal-transmitting manner.

FIG. 1 illustrates the occupant 12 in an optimum sitting position which excels by the occupant 12 sitting in an upright attitude with his/her torso 42 leaned against the backrest 32 in the driver seat 16. In this position, the occupant 12 is protected ideally by the seat belt system 10.

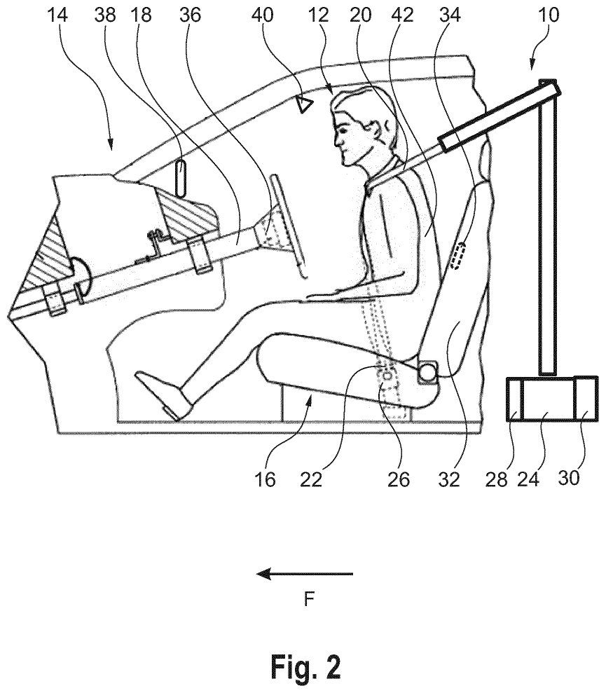

FIG. 2 illustrates the occupant 12 in a sitting position in which the occupant 12 is bent forward toward the steering wheel 18. Accordingly, the torso 42 of the occupant 12 is distant from the backrest 32 resulting in the fact that the webbing 20 is is extended farther than in the optimum sitting position (see FIG. 1). In such sitting position, the protection of the occupant 12 by the seat belt system 10 is reduced.

A sitting position in which the protective effect of the seat belt system 10 is significantly reduced is referred to as critical sitting position and is characterized in that the webbing extension exceeds a particular threshold.

In order to correct a critical sitting position of the occupant 12 and thus to better protect the occupant 12, the vehicle computer monitors the webbing extension after the belt buckle 26 has been closed. The closing of the belt buckle 26 indicates to the vehicle computer that the occupant 12 has sit down in the driver seat 16 and has fastened the seat belt webbing 20. For this purpose, the belt buckle 26 may comprise a sensor that notifies the closed state of the belt buckle 26 to the vehicle computer.

After the belt buckle 26 has been closed, the vehicle computer establishes the current webbing extension at a frequency of 100 Hz. Alternatively, the frequency by which the vehicle computer detects the current webbing extension may be optional.

Now the vehicle computer determines the threshold which represents a critical sitting position. For the threshold the following formula is applicable:

threshold=minimum belt webbing extension+admissible distance.

The minimum webbing extension constitutes the smallest value measured for the webbing extension since the belt buckle 26 has been closed. The value is measured and updated over the entire duration over which the belt buckle 26 is closed. Alternatively, the value can be measured and updated within a limited time window, especially directly after the closing of the belt buckle 26. The time window is 10, 20 or 30 seconds, for example.

The admissible distance indicates the length of the webbing 20 which can be extended without the occupant 12 reaching a critical sitting position. This means that is the admissible distance determines the “free space” which is granted to the occupant 12 and within which no reaction is triggered.

The admissible distance and thus the threshold may depend on various parameters, for example for which seat within the vehicle the seat belt system 10 is provided and in which way further protective devices such as airbags are arranged relative to said seat. In particular, the position of an airbag 36 arranged in the driving direction F in front of the occupant 12 can be taken into account.

In addition, the admissible distance may depend on how the seat position of the driver seat 16 is and/or how the position of the steering wheel 18 is.

Further, the attitude or, resp., sitting position of the occupant 12 can be taken into account by means of the camera 40 and/or the pressure sensor 34 in the admissible distance.

In an alternative embodiment, the admissible distance may further depend on the current velocity of the automotive vehicle 14, for example by reducing the admissible distance at higher velocity.

In the present case, the admissible distance amounts to 250 mm. In an alternative embodiment, the admissible distance may have any value which preferably at least partly takes the afore-mentioned parameters into account.

If the current webbing extension exceeds the threshold, for example because the occupant 12 has bent too far forward (see FIG. 2), the vehicle computer initiates a reaction to inform the occupant 12 about the critical sitting position and to correct the same, where necessary.

The reaction is to prompt the occupant 12 via the display 38 by a flashing symbol to adopt the optimum sitting position.

Further, the belt tensioner 30 is activated, thus causing the load acting on the occupant 12 by the webbing 20 to be increased. Accordingly, the maximum load is limited so that the occupant 12 will not be injured. Alternatively, the load can be increased by a fixed value, in steps or by a variable value.

In an alternative embodiment, the reaction may be initiated as late as when the threshold is exceeded for a specific period of time, for example 2 seconds. In this way, short-term changes of attitude as they are common during driving do not lead to a reaction, for instance when the driver looks over his/her shoulder or when a passenger bends forward to pick up something from the footwell.

Moreover, different reactions can be initiated at different points in time. For example, immediately after exceeding the threshold the occupant 12 is visually informed via the display 38. Unless the value falls below the threshold again within 2 seconds, the vehicle computer activates the belt tensioner 30 and thus increases the pressure of the webbing 20 on the occupant 12.

Furthermore, it may be provided that in particular driving situations no reaction is triggered, e.g. during reversing where the driver usually adopts an attitude which allows him/her to have a better view, but which deviates strongly from the optimum sitting position. This can equally be provided when the driver seat is adjusted, especially when it is longitudinally displaced and/or the backrest inclination is varied.

In this manner, the occupant 12 is informed, if his/her sitting position is within a critical range and thus the protective effect of the seat belt system 10 is relevantly reduced. Hence, the occupant 12 has the option to correct his/her sifting position on his/her own initiative, thereby increasing his/her safety.

By means of the belt tensioner 30 furthermore the attitude of the occupant 12 can be gently corrected by applying a small load. Alternatively, the occupant 12 can is automatically be moved to an upright position by applying higher load.

The method thus helps to improve the safety effect of the seat belt system 10.

The method can be used for seat belt systems 10 of any seats in a vehicle to enhance the safety of the occupants 12.

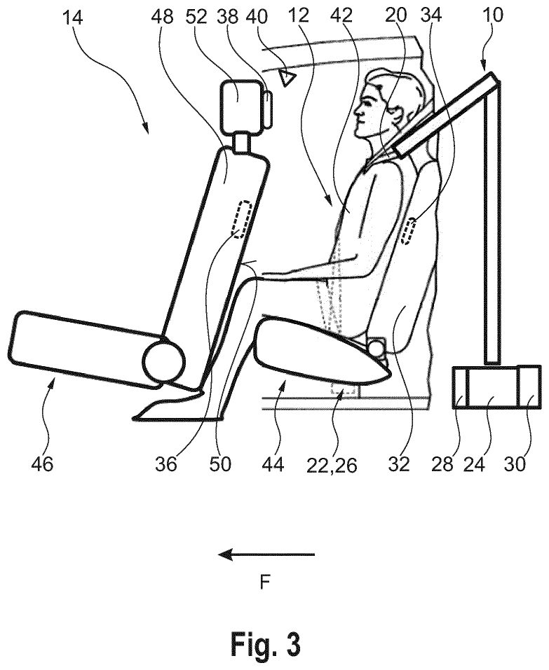

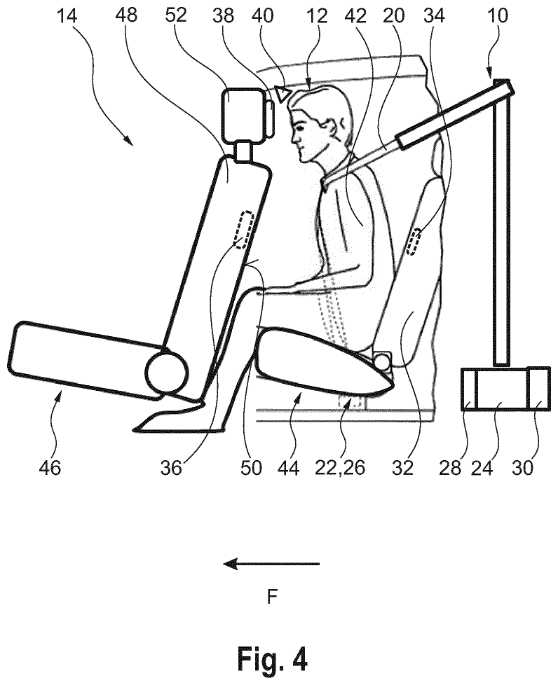

By way of example for another embodiment, FIGS. 3 and 4 illustrate a seat belt system 10 for a back seat 44 in the automotive vehicle 14 which differs from the seat belt system 10 from FIGS. 1 and 2 merely by details. Therefore, in the following like structures having like functions are provided with corresponding reference numerals.

The back seat 44 is disposed behind a front seat 46 which may be the driver seat 16, for example, in the automotive vehicle 14.

The backrest 48 of the front seat 46 is arranged with its rear side 50 facing the occupant 12 and comprises an airbag 36 provided for the occupant 12 on the back seat 44.

A display 38 is arranged in the headrest 52 of the front seat 46 and thus in the field of view of the occupant 12.

The seat belt system 10 again is connected to the vehicle computer which carries out the already described method for operating the seat belt system 10. This means that when the occupant 12 leaves its optimum sitting position illustrated in FIG. 3, for example in order to bend forward (cf. FIG. 4), and when this results in the webbing extension exceeding the threshold, a reaction is initiated to inform the occupant 12 and, resp,, to correct the critical sitting position.

When establishing the threshold, the seat position of the back seat 44 as well as the seat position of the front seat 46 are considered to take the arrangement of the seats 44, 46 and especially of the backrests 32, 48 relative to each other into account. In this way, it is safeguarded that the free space granted to the occupant 12 takes the environment of the occupant 12 into account so that the occupant will not be endangered e.g. by the airbag 36. In this way, the safety of the occupant 12 sitting on the back seat 44 is improved by the suggested method.

The invention is not limited to the shown embodiments. In particular, individual features of one embodiment may be comprised, irrespective of the other features of the corresponding embodiment, in another embodiment according to the invention, i.e. the described features can be optionally combined.

1-10. (canceled)

11. A method for operating a seat belt system (10) for an occupant (12) in a vehicle (14), the seat belt system (10) comprising a belt webbing for restraining the occupant (12), a belt buckle (26) and a sensor (28) for sensing the webbing extension, the method initiating a reaction when the webbing extension exceeds a threshold,
wherein the threshold takes the minimum webbing extension after the closing of the belt buckle (26) into account,
and wherein the threshold takes account of the minimum webbing extension within 30 seconds, preferably within 20 seconds, especially within 10 seconds after the closing of the belt buckle (26).

12. The method according to claim 11, wherein the threshold continuously takes the minimum webbing extension into account after the closing of the belt buckle (26).

13. The method according to claim 11, wherein the threshold takes the sitting position of the occupant (12) into account by means of a sensor (34, 40).

14. The method according to claims 11, wherein the threshold takes the seat position of the seat (16, 44) of the occupant (12), the seat position of the seat (46) which is arranged in the vehicle (14) in front of the seat (44) of the occupant (12) and/or the position of a steering wheel (18) into account which is arranged in the vehicle (14) in front of the seat of the occupant (12).

15. The method according to claim 11, wherein the threshold takes the position of an airbag (36) into account.

16. The method according to claim 11, wherein the threshold takes the position of an airbag (36) into account which is arranged in the driving direction (F) facing the occupant (12).

17. The method according to claim 11, wherein the reaction comprises transmitting an acoustic and/or optical signal by means of an output device (38) to transfer information to the occupant (12).

18. The method according to claim 11, wherein the reaction comprises activating a belt tensioner (30) for tensioning the webbing (20) so that the restraining force of the webbing (20) is increased.

19. The method according to claim 18, wherein the restraining force of the webbing (20) is increased by a fixed value, a value increasing continuously in time or a value varying in time.
